(19) United States
(12) Patent Application Publication
(10) Pub. No.: US 2025/0148656 A1
(43) Pub. Date: May 8, 2025

(54) INFORMATION PROCESSING DEVICE, INFORMATION PROCESSING METHOD, AND PROGRAM

(71) Applicant: Sony Group Corporation, Tokyo (JP)

(72) Inventors: Keiichi YOSHIOKA, Tokyo (JP); Kazutoshi KAWAMURA, Kanagawa (JP); Yuki NAKAI, Kanagawa (JP); Masatoshi FUKUDA, Tokyo (JP); Ken SAITO, Tochigi (JP); Tomokazu SAKAI, Tokyo (JP)

(73) Assignee: Sony Group Corporation, Tokyo (JP)

(21) Appl. No.: 18/835,353

(22) PCT Filed: Jan. 12, 2023
(86) PCT No.: PCT/JP2023/000665

§ 371 Date: Aug. 2, 2024

(30) Foreign Application Priority Data
Mar. 11, 2022 (JP) 2022-037841

(51) Int. Cl. G06T 11/00; G06T 7/11; G06T 7/73

(52) U.S. Cl. CPC G06T 11/00; G06T 7/11; G06T 7/74; G06T 2207/30201

(57) ABSTRACT

An information processing device, an information processing method, and a program that enable reduction of a burden of acquiring an imaged image of a subject are provided. The information processing device including a control unit that analyzes an imaged image acquired from one or more imaging devices that image a target space, determines one or more subjects as clipping targets from the imaged image, and performs control for clipping a determined subject.

### TECHNICAL FIELD

The present disclosure relates to an information processing device, an information processing method, and a program.

### BACKGROUND ART

Conventionally, recording distribution (distribution of recorded video) and live distribution (real-time distribution) of events such as music concerts and sports are performed. The viewers can perform viewing using a smartphone, a tablet terminal, a TV, a personal computer (PC), or the like.

With regard to such video distribution, for example, Patent Document 1 below discloses a technique related to appropriate editing of contents that have been distributed live.

### CITATION LIST

### Patent Document

Patent Document 1: WO 2018/173876 A

### SUMMARY OF THE INVENTION

### Problems to be Solved by the Invention

However, in the conventional distribution, in a case where a subject is imaged in an event venue, selection of which subject is to be imaged and angle of view adjustment to the subject have been performed manually, which have taken time and effort.

Therefore, the present disclosure proposes an information processing device, an information processing method, and a program that enable reduction of a burden of acquiring an imaged image of a subject.

### Solutions to Problems

According to the present disclosure, there is provided an information processing device including a control unit that analyzes an imaged image acquired from one or more imaging devices that image a target space, determines one or more subjects as clipping targets from the imaged image, and performs control for clipping a determined subject.

Furthermore, according to the present disclosure, there is provided an information processing method performed by a processor, including analyzing an imaged image acquired from one or more imaging devices that image a target space, determining one or more subjects as clipping targets from the imaged image, and performing control for clipping a determined subject.

Furthermore, according to the present disclosure, there is provided a program that causes a computer to function as a control unit that analyzes an imaged image acquired from one or more imaging devices that image a target space, determines one or more subjects as clipping targets from the imaged image, and performs control for clipping a determined subject.

### BRIEF DESCRIPTION OF DRAWINGS

FIG. 1 is a diagram illustrating an outline of a distribution system according to an embodiment of the present disclosure.

FIG. 2 is a block diagram illustrating an example of a configuration of a content generation device according to the present embodiment.

FIG. 3 is a diagram illustrating an example of a position adjustment screen 400 displayed on a display unit of the content generation device according to the present embodiment.

FIG. 4 is a diagram illustrating an example of a clipped image display screen according to the present embodiment.

FIG. 5 is a diagram for describing clipping of a subject positioned in a region of interest according to the present embodiment.

FIG. 6 is a diagram for describing a clipping range according to the present embodiment.

FIG. 7 is a diagram illustrating a clipping range in a case where a plurality of subjects is included according to the present embodiment.

FIG. 8 is a diagram illustrating switching of an imaged image of a clipping source by movement of a subject according to the present embodiment.

FIG. 9 is a diagram for describing designation of a recognition area according to the present embodiment.

FIG. 10 is a block diagram illustrating an example of a configuration of a distribution switching device according to the present embodiment.

FIG. 11 is a flowchart illustrating an example of a flow of operation processing of the content generation device according to the present embodiment.

FIG. 12 is a diagram illustrating another method of using a clipped image according to an application example of the present embodiment.

### MODE FOR CARRYING OUT THE INVENTION

Hereinafter, a preferred embodiment of the present disclosure will be described in detail with reference to the accompanying drawings. Note that, in the present specification and drawings, components having substantially the same functional configuration are denoted by the same reference signs, and redundant description is omitted.

Furthermore, a description will be given in the following order.
1. Outline of distribution system according to embodiment of present disclosure
2. Configuration example
2-1. Configuration example of content generation device 20
2-2. Configuration example of distribution switching device 30
3. Operation processing
4. Application examples
5. Supplement notes

### 1. Outline of Distribution System According to Embodiment of Present Disclosure

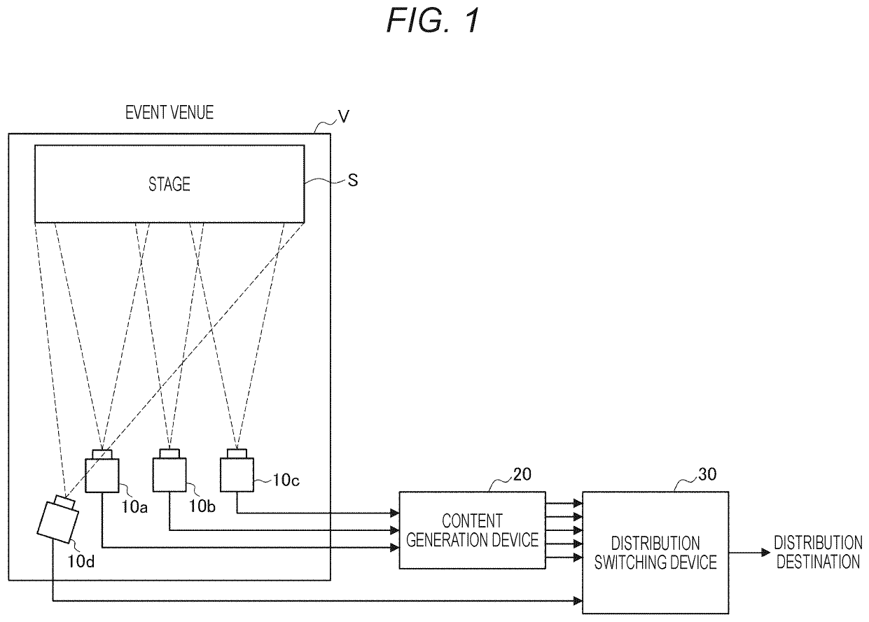

FIG. 1 is a diagram illustrating an outline of a distribution system according to an embodiment of the present disclosure. As illustrated in FIG. 1, in the present embodiment, a case where a state of an event venue V where a music concert, a musical, or the like is performed is distributed live will be described. Specifically, the distribution system according to the present embodiment includes cameras 10a to 10d (example of imaging devices) that image a stage S (example of a target space) of the event venue V, a content generation device 20 (example of an information processing device) that generates contents (specifically, images) as distribution candidates, and a distribution switching device 30 that switches the contents to be distributed.

The event venue V may be a facility including the stage S and audience seats, or may be a recording room (recording studio).

The cameras 10a to 10c are installed in the event venue V and can image each region of the stage S. Although the angles of view of the cameras 10a to 10c are different, imaging is performed in a state where the cameras partially overlap each other as illustrated in FIG. 1. Imaged images obtained by imaging by the cameras 10a to 10c are output to the content generation device 20 and used for clipping a subject in the content generation device 20. The cameras 10a to 10c may be, for example, a 4K camera, an 8K camera, or a 16K camera. The resolution of the cameras 10a to 10c is desirably resolution with which a clipped image that can be fit for viewing can be obtained in a case where a subject is clipped from an imaged image, but is not particularly limited thereto. Furthermore, the cameras 10a to 10c can be arranged and installed side by side on the seat side of the stage S. Furthermore, the number of cameras 10 is any number. The number of cameras 10 may be one or more.

Furthermore, a camera 10d including the entire stage S in the angle of view may be further included. An imaged image (overhead image of the stage S) obtained by imaging by the camera 10d is not used for clipping in the content generation device 20, but is output to the distribution switching device 30. The camera 10d may be, for example, a high definition (HD) camera. The resolution of the camera 10d may be, for example, resolution lower than that of the cameras 10a to 10c that acquire imaged images used for clipping a subject, but is not particularly limited thereto. Furthermore, a plurality of cameras that acquires imaged images not used for clipping a subject may be installed. For example, a camera that images the entire stage S from a direction different from that of the camera 10d may be further installed.

The content generation device 20 is an information processing device that clips one or more subjects from each of the imaged images obtained by imaging by the cameras 10a to 10c and performs control for generating one or more clipped images of the subjects as contents of distribution candidates. The content generation device 20 transmits the clipped images to the distribution switching device 30. For image output from the content generation device 20 to the distribution switching device 30, for example, serial digital interface (SDI) output is used. The content generation device 20 clips images by the number of outputs (specifically, by the number of SDI outputs).

The distribution switching device 30 is a device that performs switching (selection) control of an image to be distributed to a distribution destination (specifically, viewer terminal). A plurality of images such as clipped images output from the content generation device 20 and imaged images obtained by imaging by the camera 10d can be input to the distribution switching device 30. The distribution switching device 30 selects an image to be output (distributed) from among the plurality of input images, and outputs the image to the distribution destination. Furthermore, the distribution switching device 30 appropriately switches (newly selects) an image to be distributed. The switching (selection) may be freely performed by the operator (for example, switcher) or may be automatically performed.

### (Review of Issues)

Here, in the conventional distribution, a large number of cameras have been arranged in an event venue, cameramen have engaged in the respective cameras, and a camera operation including angle of view adjustment (zoom operation, operation of imaging direction, and the like) to a subject has been manually performed. For example, in a case where a large number of performers such as a group of idols are on a stage, conventionally, which subject is tracked by which camera at which timing and the like have been freely determined in advance on the basis of song division and the like, and camera work rehearsal has been performed. As described above, in the conventional distribution, in a case where a subject is imaged in an event venue, selection of which subject is to be imaged and angle of view adjustment to the subject have been performed manually, which have taken time and effort.

Therefore, in the distribution system according to the present disclosure, a burden of acquiring an imaged image of a subject can be reduced, and the number of people can be reduced at the time of imaging. For example, by any subject being automatically clipped from imaged images obtained by imaging by the plurality of cameras 10a to 10c installed in the event venue V illustrated in FIG. 1, an imaged image of a subject can be appropriately acquired without an operation by a cameraman. Even in a case where a large number of subjects are on the stage, the work load can be reduced by a subject as a clipping target being automatically determined.

The outline of the distribution system according to the embodiment of the present disclosure has been described above. Subsequently, a configuration of each device included in the distribution system according to the present embodiment will be described with reference to the drawings.

### 2. Configuration Example

### <2-1. Configuration Example of Content Generation Device 20>

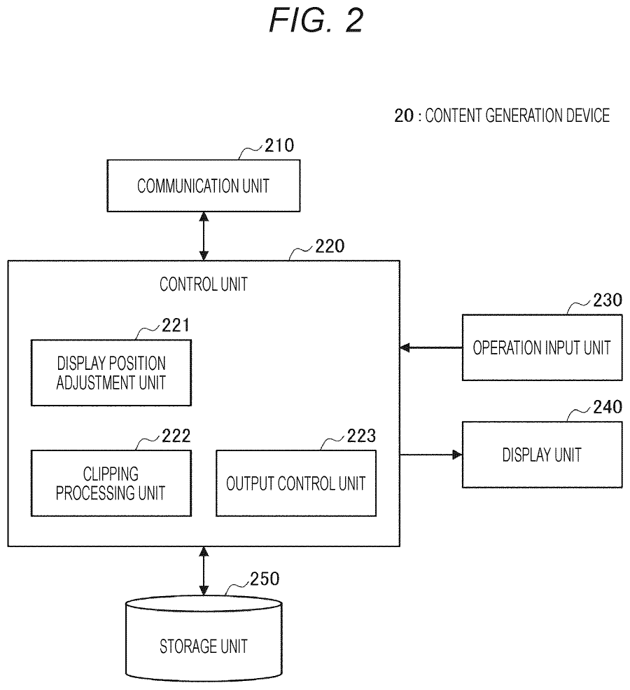

FIG. 2 is a block diagram illustrating an example of a configuration of the content generation device 20 according to the present embodiment. As illustrated in FIG. 2, the content generation device 20 includes a communication unit 210, a control unit 220, an operation input unit 230, a display unit 240, and a storage unit 250. The content generation device 20 is used, for example, by a director who directs an entire event.

### (Communication Unit 210)

The communication unit 210 includes a transmission unit that transmits data to an external device in a wired or wireless manner and a reception unit that receives data from the external device. The communication unit 210 is communicably connected to the cameras 10a to 10c and the distribution switching device 30 using, for example, a wired/wireless local area network (LAN), Wi-Fi (registered trademark), Bluetooth (registered trademark), a mobile communication network (long term evolution (LTE), a fourth generation mobile communication system (4G), or a fifth generation mobile communication system (5G)), or the like.

Furthermore, the communication unit 210 can also function as a transmission unit that transmits (outputs) a subject clipped image to the distribution switching device 30. As a specific output method, SDI output may be used. The output of an image can be performed separately from data transmission performed using the LAN or the like.

### (Control Unit 220)

The control unit 220 functions as an arithmetic processing device and a control device, and controls the overall operation in the content generation device 20 according to various programs. The control unit 220 is implemented by, for example, an electronic circuit such as a central processing unit (CPU), a microprocessor, or the like. Furthermore, the control unit 220 may also include a read only memory (ROM) that stores programs, arithmetic parameters, and the like to be used, and a random access memory (RAM) that temporarily stores parameters and the like that change as appropriate. Furthermore, the control unit 220 may include a graphics processing unit (GPU).

Furthermore, the control unit 220 also functions as a display position adjustment unit 221, a clipping processing unit 222, and an output control unit 223.

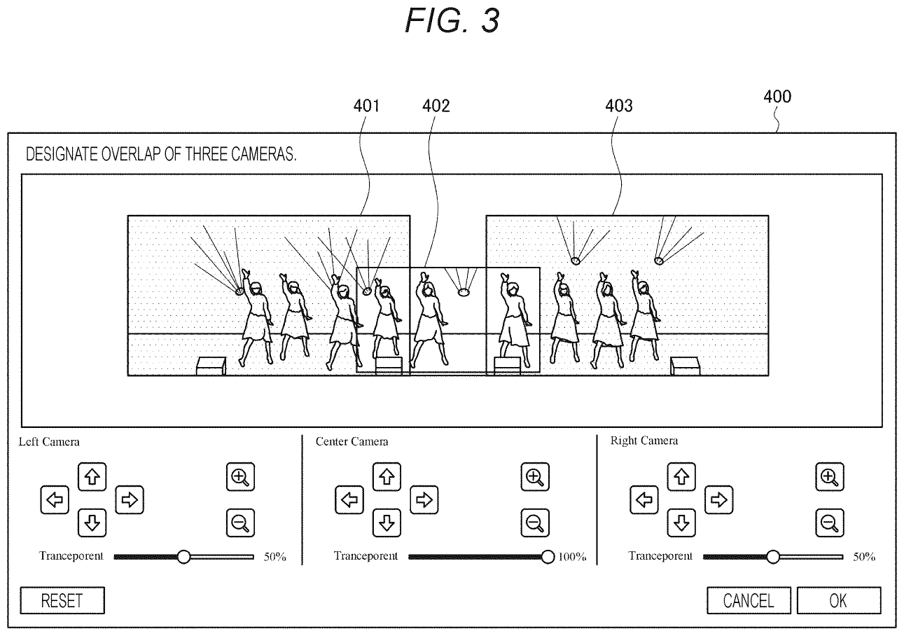

The display position adjustment unit 221 performs processing of arranging and displaying a plurality of imaged images having partially overlapping view angles acquired from the cameras 10a to 10c that are a plurality of imaging devices disposed on the seat side of the stage S side by side in a partially overlapping state on the display unit 240, and processing of receiving adjustment of an overlapping position of the plurality of imaged images. Such adjustment can be performed by an operator (for example, director) in a preparation phase before the event starts. In the preparation phase, first, the cameras 10a to 10c are disposed on the seat side so that the entire stage S can be imaged in a shared manner. For example, in the example illustrated in FIG. 1, the left side of the stage S is mainly imaged by the camera 10a, the center of the stage S is mainly imaged by the camera 10b, and the right side of the stage S is mainly imaged by the camera 10c. At this time, the angle of view (imaging range) of each camera 10 can be set such that the angle of view (imaging range) of the adjacent camera 10 is partially overlapped. For example, in FIG. 1, the left end of the imaging range of the camera 10b positioned at the center overlaps the right end of the imaging range of the camera 10a positioned on the left side, and the right end of the imaging range of the camera 10b positioned at the center overlaps the left end of the imaging range of the camera 10c positioned on the right side. Next, the display position adjustment unit 221 arranges and displays imaged images of the cameras 10a to 10c side by side on the display unit 240. Hereinafter, a specific description will be given with reference to FIG. 3.

FIG. 3 is a diagram illustrating an example of a position adjustment screen 400 displayed on the display unit 240 of the content generation device 20 according to the present embodiment. As illustrated in FIG. 3, on the position adjustment screen 400, an imaged image 401 obtained by imaging by the camera 10a, an imaged image 402 obtained by imaging by the camera 10b, and an imaged image 403 obtained by imaging by the camera 10c are arranged and displayed side by side. Furthermore, the position adjustment screen 400 includes an operation screen for operating the display position, the display size, and the transparency of each of the imaged images 401 to 403. An operator (for example, director) of the content generation device 20 moves a display position of each of the imaged images 401 to 403 up and down, left and right, enlarges/reduces a display size, and adjusts an overlapping position while checking overlapping of a subject by transmitting imaged images. More specifically, the operator adjusts the display position of an imaged image such that subjects in the overlapping region match. The display position adjustment unit 221 receives input of an adjustment operation of a display position, and stores the adjustment result (display position and display size of each of the imaged images) in the storage unit 250. The adjustment result may be at least information of an overlapping position of each of the imaged images (which region of the imaging range overlaps which region of the imaging range of which camera).

Note that, in the present embodiment, the operator manually performs the adjustment from the position adjustment screen 400 as an example, but the present disclosure is not limited thereto, and the adjustment may be automatically performed by the display position adjustment unit 221. Furthermore, the operator may be caused to check the result of the automatic adjustment.

The clipping processing unit 222 analyzes imaged images acquired from one or more imaging devices (for example, cameras 10a to 10c) that image a target space (for example, stage S), determines one or more subjects as clipping targets from the imaged images, and performs control for clipping the determined subjects. Such clipping processing can be continuously performed from the start of distribution of the event (start of imaging). Specifically, the processing is performed for each frame.

First, the clipping processing unit 222 performs image analysis on the imaged image 401 to 403 and identifies subjects by object recognition. Here, examples of a subject include a human, an animal, an object, and the like, but in the present embodiment, a human performing performance on a stage is assumed. The clipping processing unit 222 may perform face detection as identification of a subject. Next, the clipping processing unit 222 determines a subject that satisfies a predetermined condition among the identified subjects as a clipping target and performs clipping.

An image clipped by the clipping processing unit 222 (clipped image; imaged image of the subject) is output to the distribution switching device 30 and the display unit 240 by the output control unit 223. The output control unit 223 can perform control for outputting (transmitting) one or more clipped images from the communication unit 210 to the distribution switching device 30 and control for outputting (displaying) the clipped images to the display unit 240. Furthermore, the output control unit 223 may output the clipped images to the distribution switching device 30 and transmit a distribution switching control signal to the distribution switching device 30. For example, a signal indicating a clipped image having high distribution priority (the signal is information used for controlling distribution switching in the distribution switching device 30) such as a singing subject or a subject in a region of interest may be transmitted.

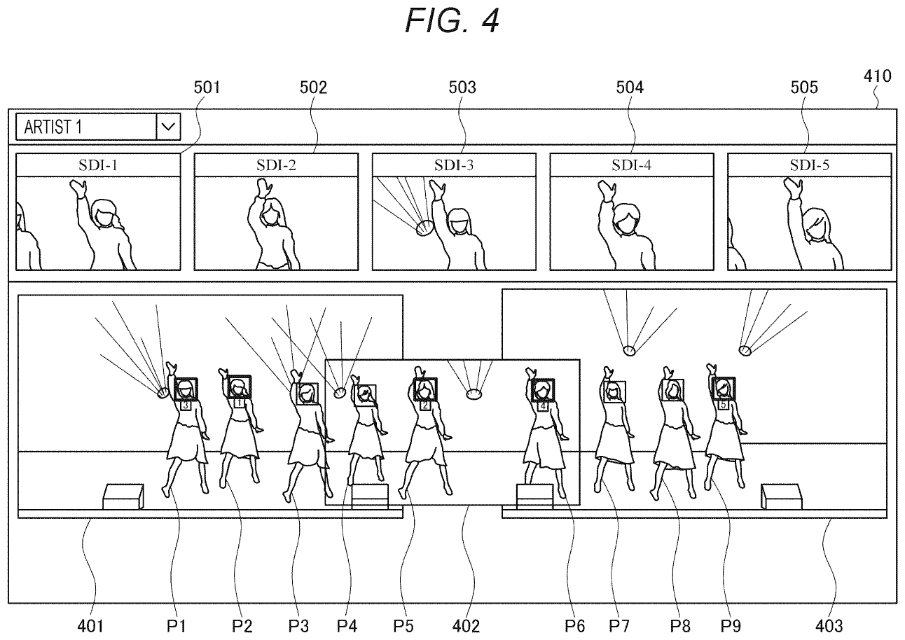

Here, a display example of clipped images will be described with reference to FIG. 4. FIG. 4 is a diagram illustrating an example of a clipped image display screen 410 according to the present embodiment. The clipped image display screen 410 illustrated in FIG. 4 is displayed on the display unit 240 of the content generation device 20 during event distribution. By visually recognizing the clipped image display screen 410, the director can intuitively grasp subjects identified by the system and images (clipped images) that have been preferentially clipped by the system and output (SDI output) to the distribution switching device 30.

Specifically, as illustrated in FIG. 4, the imaged images 401 to 403 acquired from the respective cameras 10a to 10c and clipped images 501 to 505 clipped from the respective imaged images 401 to 403 are displayed on the clipped image display screen 410. Associated SDI output numbers are assigned to the clipped images 501 to 505. The clipped images 501 to 505 are SDI output to the distribution switching device 30.

Furthermore, the imaged images 401 to 403 displayed on the clipped image display screen 410 are arranged and displayed side by side in a partially overlapping state according to a result of adjustment in advance by the display position adjustment unit 221. The imaged images 401 to 403 illustrated in FIG. 4 include subjects P1 to P9, and a result of face detection of each of the subjects is clearly indicated by a frame line (frame line surrounding the face). As a result, the director can intuitively grasp that the subjects are recognized by the system. Furthermore, the frame line of a subject determined as a clipping target may be emphasized and displayed. Furthermore, the SDI output number associated with the clipped image of a subject determined as a clipping target is also displayed on the frame line of the subject. As a result, the director can intuitively grasp which subject is determined to be a clipping target by the system and the clipped image of the determined subject.

Next, the clipping processing by the clipping processing unit 222 described above will be described more specifically.

The clipping processing unit 222 determines a subject that satisfies a predetermined condition as a clipping target and performs clipping, and the “predetermined condition” includes, for example, performing a predetermined action. The clipping processing unit 222 preferentially determines a subject recognized as a subject performing a predetermined action as a clipping target. The clipping processing unit 222 may recognize a predetermined action by analyzing an imaged image. Furthermore, the clipping processing unit 222 may recognize a predetermined action on the basis of sensing data other than an imaged image.

An example of the predetermined action is a singing action. The clipping processing unit 222 determines a singing subject as a clipping target as a subject that satisfies a predetermined condition. In a case where a group of a large number of idols or the like are subjects, the clipping processing unit 222 preferentially determines a singing subject as a clipping target. This is because tracking a person singing using a camera is important in a music concert.

Examples of a method of determining whether or not singing is performed include the following examples. For example, the clipping processing unit 222 analyzes an imaged image so as to estimate the skeleton of a subject, and determines that the singing is performed in a case where the subject raises a hand holding a hand microphone. Furthermore, the clipping processing unit 222 determines that singing is performed in a case where a sound source is turned on (in a case where a microphone is turned on) on the basis of information of the microphone of the subject (hand microphone held by the subject, headset microphone mounted on the subject, stand microphone standing in front of the subject, or the like). Furthermore, the clipping processing unit 222 determines that singing is performed in a case where the motion of the microphone is detected on the basis of information of an acceleration sensor or the like included in the microphone of the subject. Furthermore, the clipping processing unit 222 performs image recognition of the imaged image, and determines that singing is performed in a case where the mouth of the subject is open. Furthermore, the clipping processing unit 222 determines that singing is performed in a case where the subject is at a predetermined position at a predetermined timing (set in advance on the basis of a song division and a standing position) on the basis of position information of the subject on the stage. The position information of the subject on the stage is obtained by a sensor (for example, ultra-wideband (UWB) position information tag) held by the subject or by image recognition.

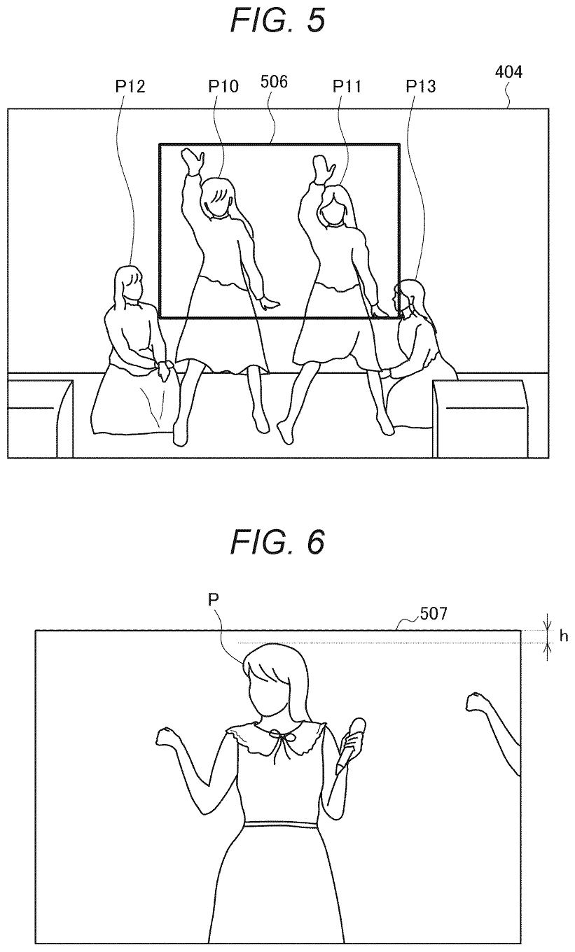

Furthermore, examples of the “predetermined condition” include being positioned in a region of interest. The clipping processing unit 222 determines a region of interest, and determines a subject positioned in the region of interest as a clipping target as a subject that satisfies a predetermined condition. This is because, in a music concert or the like, a region of interest (region to which attention is desirably paid for production) may be temporarily created. The clipping processing unit 222 recognizes the motion of each subject by, for example, skeleton estimation or the like, and determines a region with motion (region having a larger motion amount than other regions). For example, in a case where only one person or a specific group (group of a plurality of subjects) starts to move, the clipping processing unit 222 preferentially determines the subject or the group as a clipping target. FIG. 5 is a diagram for describing clipping of a subject positioned in a region of interest according to the present embodiment. As illustrated in FIG. 5, in an imaged image 404 acquired from a camera 10 (any one of 10a to 10c), in a case where only a specific group (subjects P10 and P11) is moving and the other subjects P12 and P13 are stationary, the clipping processing unit 222 determines the subjects P10 and P11 as clipping targets as a group, and performs clipping from the imaged image 404 (a clipped image 506 is generated).

Furthermore, examples of the “predetermined condition” include being positioned at the center on the stage. This is because a subject to which attention is to be paid is often positioned at the center of the stage in a music concert or the like. The clipping processing unit 222 determines a subject positioned at the center on the stage as a clipping target as a subject that satisfies a predetermined condition.

Furthermore, the clipping processing unit 222 can perform clipping in a range including one subject (single clipping) or clipping in a range including a plurality of subjects (group clipping). As described with reference to FIG. 5, the group clipping can be performed, for example, in a case where clipping is performed on the basis of a region of interest.

Furthermore, the clipping processing unit 222 clips a subject (generates a clipped image) by the number of clippings corresponding to the number of image outputs to the distribution switching device 30. The number of image outputs is, for example, the number of SDI outputs, and can be defined in advance.

Furthermore, the clipping processing unit 222 may preferentially determine a subject identified from an imaged image as a clipping target. In a case where the number of identified subjects is equal to or larger than the number of clippings, the clipping processing unit 222 preferentially clips a subject that satisfies a condition in accordance with each predetermined condition described above. Furthermore, the clipping processing unit 222 may determine a subject as a clipping target by combining each predetermined condition described above. For example, in a case where the number of identified subjects is equal to or larger than the number of clippings and all the subjects are singing, the clipping processing unit 222 may preferentially determine a subject close to the center as a clipping target. Furthermore, in a case where subjects can be identified and popularity information of each of the subjects is input, the clipping processing unit 222 may preferentially determine a popular subject as a clipping target.

On the other hand, in a case where the number of identified subjects is less than the number of clippings, the clipping processing unit 222 may determine a fixed position on the stage as a clipping target. For example, at the start, transition, end, or the like of a music concert, a subject may appear on the stage after a period of time. In this case, the clipping processing unit 222 preferentially clips video at a fixed position such as the center on the stage or an appearance position (that can be set in advance) of a subject on the stage.

The determination of a clipping target has been described above. Note that a subject as a clipping target can be freely designated by an operator (for example, director) of the content generation device 20. The operator designates a subject to be a clipping target on the clipped image display screen 410 as illustrated in FIG. 4, for example. The designation method is any method, but for example, designation may be performed by performing a touch operation on a subject appearing in the imaged images 401 to 403 displayed on the clipped image display screen 410. Furthermore, designation may be performed by moving display of the frame line surrounding the face of a subject to the face of another subject by dragging and dropping.

Next, a range of clipping by the clipping processing unit 222 will be specifically described.

The clipping processing unit 222 clips a subject in a range including at least the face of the subject. Furthermore, the clipping processing unit 222 may perform clipping in a range including at least the face of the subject, the range being zoomed in (enlarged) to a limit value of the resolution (resolution at a level that can be fit for viewing). The limit value of the resolution may be set in advance. Furthermore, the clipping processing unit 222 may clip a subject in a range further including at least a hand of the subject. In consideration of the choreography of the subject, clipping a subject in a range including at least the face and a hand may be desirable.

Furthermore, the clipping processing unit 222 may determine a clipping range (whether there is included only the face, a hand, the upper body, the whole body, or the like) on the basis of the skeleton estimation of a subject. For example, in a case where it is recognized by the skeleton estimation that a hand is drastically moved due to the choreography or the like, the clipping processing unit 222 may set a clipping range including the hand.

Furthermore, the clipping processing unit 222 may perform clipping in a range including a predetermined margin above the uppermost part of the body of the subject (clipping target). The uppermost part of the body is a part positioned at the highest position of the person, and is assumed to be normally the head or a hand in a case where the hand is raised. FIG. 6 is a diagram for describing a clipping range according to the present embodiment. For example, as illustrated in FIG. 6, the clipping processing unit 222 acquires (generates) a clipped image 507 in a range including a margin h above the head that is the uppermost part of a subject P.

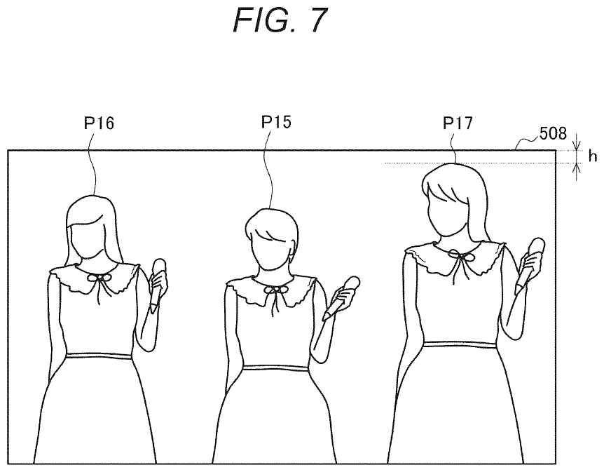

Furthermore, a case is assumed where, in a case where the clipping processing unit 222 clips a subject as a clipping target in a range enlarged to the limit value of the resolution including at least the face, another subject in the vicinity appears in the clipping range. In this case, the clipping processing unit 222 temporarily includes, in a clipping target, a subject whose half or more of the body appears in the clipping range or a subject who appears in the clipping range to the extent that the recognition can be performed by skeleton estimation, and performs clipping in a range according to the heights of all subjects. A specific example is described with reference to FIG. 7.

FIG. 7 is a diagram illustrating a clipping range in a case where a plurality of subjects is included according to the present embodiment. In FIG. 7, a case is assumed where, in a case where a subject P15 is determined as a clipping target, a subject P16 and a subject P17 in the vicinity appear in a clipping range. In this case, the clipping processing unit 222 acquires (generates) a clipped image 508 in a range including a margin h above the uppermost part of the bodies of all the subjects (head of the subject P17). As a result, clipping an image in which a head is cut unnaturally can be avoided. Such adjustment of a clipping range in a case where a plurality of subjects is included can also be applied to a case of the group clipping described above.

Note that, even if the number of subjects increases in a clipping range in a case where a clipped image is selected for distribution (programmed out) by the distribution switching device 30, the clipping processing unit 222 may keep the height of the clipping range according to a subject determined as a clipping target in a case where the image is selected for distribution. Furthermore, in a case where a clipped image is selected for distribution (programmed out) by the distribution switching device 30 and subjects are reduced in the clipping range (in a case where a subject temporarily determined as a clipping target is out of the clipping range), the clipping processing unit 222 may not change the height of the clipping range. With this arrangement, the quality of an image being programmed out is maintained.

Although adjustment of a clipping range in a case where a subject appears has been described above, the present embodiment is not limited thereto, and a clipping range may be set only according to a subject determined as a clipping target without considering a subject even in a case where the subject appears.

Furthermore, the clipping processing unit 222 may apply smoothing in the moving direction of a clipping range between frames such that the motion of a subject in continuous clipped images (clipping video including a plurality of frames) looks natural. Examples of the type of smoothing include an average value, a weighted average, and the like of the moving amount for frames in a certain section. The clipping processing unit 222 can take the average value of coordinate positions of a subject determined as a clipping target and loosen the moving amount of the clipping range (does not give influence of subtle motion of the subject).

Furthermore, in a case where the eye line of a subject as a clipping target is directed to the left and right (in a case where the face is directed sideways), the clipping processing unit 222 may further perform clipping in a range including a large margin in the eye line direction (face direction). With this arrangement, a clipped image having refined composition that causes depth or line-of-sight guidance to the viewer can be obtained.

Furthermore, the clipping processing unit 222 may perform clipping in a range including a plurality of subjects (group clipping) or clipping in a range including only one subject included in the plurality of subjects (single clipping). That is, both the group clipping and the single clipping may be simultaneously performed on one subject as a clipping target. With this arrangement, for example, it can be expected that, in a case where a group clipped image and a single clipped image are switched in the distribution switching device 30, the viewer can be caused to feel a dynamic feeling and given a realistic feeling of a music concert or the like.

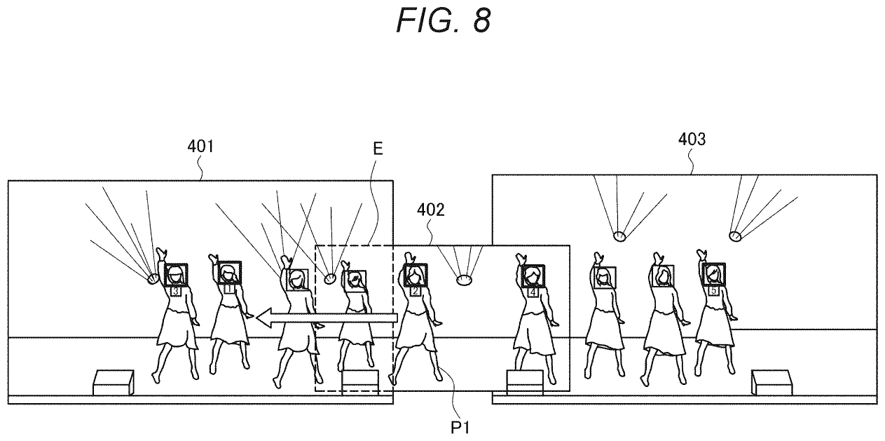

Next, an imaged image of a clipping source in a case where clipping is performed by the clipping processing unit 222 will be described. In a case where a subject is included in an overlapping region adjusted in advance by the display position adjustment unit 221, the clipping processing unit 222 clips the subject from any imaged image. Furthermore, it is assumed that a subject performs a vigorous movement such as running around on the stage particularly in a concert or the like of a large number of idols. Even in such a case, the clipping processing unit 222 needs to keep tracking (keep clipping) a subject as a clipping target. Therefore, in a case where a subject as a clipping target (also referred to as tracking target) moves across a plurality of imaged images, the clipping processing unit 222 may switch the imaged image of the clipping source at the time when the subject enters an overlapping region and continue tracking. That is, in a case where a subject as a clipping target moves from a first imaged image to a second imaged image of a plurality of imaged images arranged side by side, the clipping processing unit 222 switches the imaged image of the clipping source at a portion where the first imaged image and the second imaged image overlap. Hereinafter, a specific description will be given with reference to FIG. 8.

FIG. 8 is a diagram illustrating switching of an imaged image of a clipping source by movement of a subject according to the present embodiment. As illustrated in FIG. 8, in a case where the imaged images 401 to 403 are arranged side by side in a partially overlapping state, for example, it is assumed that the subject P1 as a clipping target included only in the range of the imaged image 402 moves in the left direction (range of the imaged image 401). In this case, when the subject P1 enters an overlapping region E between the imaged image 402 and the imaged image 401, the clipping processing unit 222 switches the clipping source of the subject from the imaged image 402 to the imaged image 401. As a result, even if the subject P1 moves to a position included only in the range of the imaged image 401, smooth tracking (continuing clipping the subject P1) can be performed.

Note that, in a case where the angle of view of the switched imaged image of the clipping source is different, the zoom factor appears to have changed on the clipped image output to the distribution switching device 30. Furthermore, as a countermeasure against a mix-up in a case where persons overlap each other in an overlapping region (front and back), it is conceivable to discriminate and identify a feature (color of clothing, hairstyle, or the like) of a subject as a tracking target, or to collate and identify the moving direction of the subject by combining a depth sensor. Furthermore, it is also possible to discriminate and identify the position of the subject by combining a position measurement sensor (for example, causing the subject to carry an identifiable tag).

Furthermore, the clipping processing unit 222 is not limited to tracking of a subject, and may perform clipping (fixed position clipping) of a predetermined area (set in advance) on the stage. Specifically, the clipping processing unit 222 determines one or more subjects in a predetermined area on the stage as clipping targets, and performs clipping in a range including the subjects. Then, the clipping processing unit 222 does not perform tracking even if the subjects come out of the predetermined area.

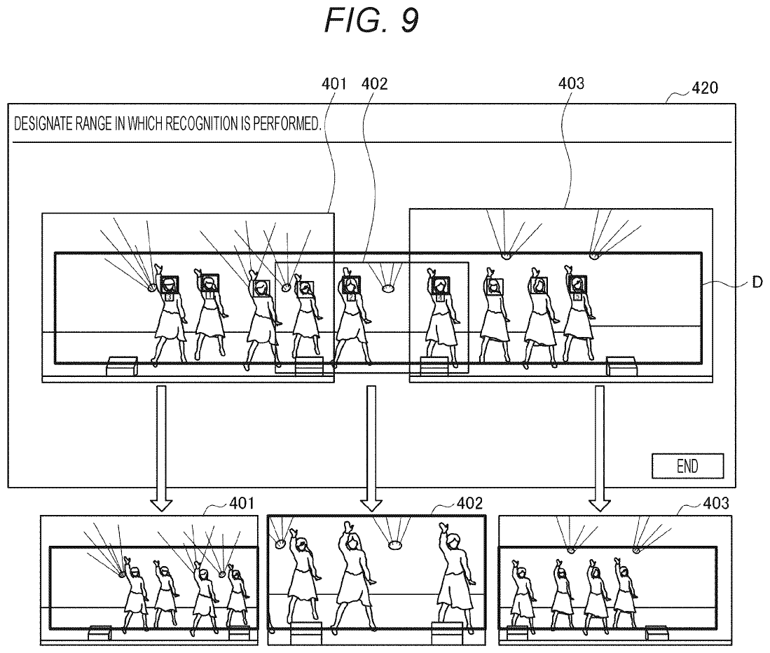

Next, designation of a recognition area of a subject by the clipping processing unit 222 in an imaged image will be described. For example, it is possible to designate an area in which image recognition is performed so as not to erroneously detect an audience or a person appearing on a back screen on a stage as a subject (performer). FIG. 9 is a diagram for describing designation of a recognition area according to the present embodiment. On a recognition area designation screen 420 illustrated in FIG. 9, the imaged images 401 to 403 are arranged and displayed side by side in a partially overlapping state. Furthermore, rectangular recognition frames D are displayed on the imaged images 401 to 403. An operator (for example, director) of the content generation device 20 can designate the recognition area by adjusting the position and size of a recognition frame D (for example, not including an audience or the back screen). The clipping processing unit 222 calculates the coordinate position of the designated recognition frame D, and sets the recognition area (image analysis region) in each of the imaged images 401 to 403 as illustrated in the lower part of FIG. 9. The clipping processing unit 222 performs image analysis within such a recognition area and identifies a subject. Note that the adjustment of a recognition frame D is not limited to manual adjustment, and may be automatically performed by the content generation device 20.

The clipping processing by the clipping processing unit 222 has been specifically described above. Next, referring back to FIG. 2, the description of each configuration will be continued.

### (Operation Input Unit 230 and Display Unit 240)

The operation input unit 230 receives an operation input by an operator and outputs input information to the control unit 220. Furthermore, the display unit 240 displays various operation screens and each screen described with reference to FIGS. 3, 4, and 9. The display unit 240 may be a display panel such as a liquid crystal display (LCD) or an organic electro luminescence (EL) display. The operation input unit 230 and the display unit 240 may be included integrally. For example, the operation input unit 230 may be a touch sensor laminated on the display unit 240 (for example, panel display).

### (Storage Unit 250)

The storage unit 250 is implemented by a read only memory (ROM) that stores programs, arithmetic parameters, and the like to be used for processing of the control unit 220, and a random access memory (RAM) that temporarily stores parameters and the like that change as appropriate.

Although the configuration of the content generation device 20 has been specifically described above, the configuration of the content generation device 20 according to the present disclosure is not limited to the example illustrated in FIG. 2. For example, the content generation device 20 may not include the operation input unit 230 and the display unit 240. Furthermore, the content generation device 20 may be implemented by a plurality of devices. Furthermore, at least some of the functions of the content generation device 20 may be implemented by a server.

### <2-2. Configuration Example of Distribution Switching Device 30>

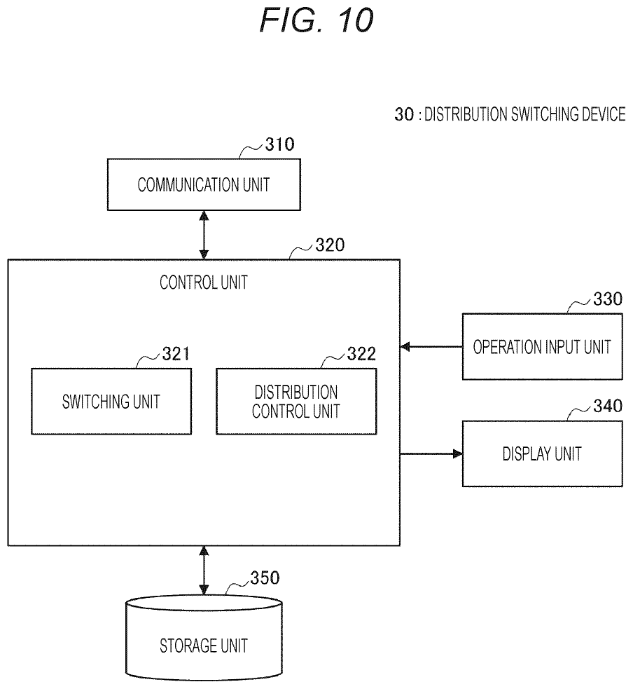

FIG. 10 is a block diagram illustrating an example of a configuration of the distribution switching device 30 according to the present embodiment. As illustrated in FIG. 10, the distribution switching device 30 includes a communication unit 310, a control unit 320, an operation input unit 330, a display unit 340, and a storage unit 350. An operator of the distribution switching device 30 may be a switcher in a position for switching a distribution image.

### (Communication Unit 310)

The communication unit 310 includes a transmission unit that transmits data to an external device in a wired or wireless manner and a reception unit that receives data from the external device. The communication unit 310 is communicably connected to the content generation device 20 and a distribution destination using, for example, a wired/wireless local area network (LAN), Wi-Fi (registered trademark), Bluetooth (registered trademark), a mobile communication network (long term evolution (LTE), a fourth generation mobile communication system (4G), or a fifth generation mobile communication system (5G)), or the like.

More specifically, SDI may be used for inputting a subject clipped image from the content generation device 20 by the communication unit 210. Furthermore, the Internet may be used for transmission (distribution) of an image to a distribution destination by the communication unit 210.

### (Control Unit 320)

The control unit 320 functions as an arithmetic processing device and a control device, and controls the overall operation in the distribution switching device 30 according to various programs. The control unit 320 is implemented by, for example, an electronic circuit such as a central processing unit (CPU), a microprocessor, or the like. Furthermore, the control unit 320 may also include a read only memory (ROM) that stores programs, arithmetic parameters, and the like to be used, and a random access memory (RAM) that temporarily stores parameters and the like that change as appropriate.

The control unit 320 also functions as a switching unit 321 and a distribution control unit 322.

The switching unit 321 switches (selects) an image to be distributed (programmed out) to a distribution destination (viewer terminal). Specifically, the switching unit 321 selects one image to be distributed from among a plurality of clipped images SDI output from the content generation device 20. Then, the distribution control unit 322 performs control for distributing the selected image from the communication unit 310 to the distribution destination.

The switching unit 321 may automatically select an image to be distributed according to a control signal from the content generation device 20. For example, five clipped images obtained by clipping respective five subjects and a signal for designating, among the five clipped images, clipped images of respective two persons whose singing action has been recognized as images having high distribution priority are input from the content generation device 20. The switching unit 321 randomly selects one of the two clipped images designated as images having high distribution priority (images of the singing subjects). Note that, in a case where there is a plurality of singing subjects, the content generation device 20 sets distribution priority to be high for a subject close to the center, and the switching unit 321 can perform selection according to the setting. Furthermore, the distribution priority may also be set high for a subject in a region of interest. For the sake of production, in a case where there is a clipped image of a subject in a region of interest, the clipped image may be always selected (as an image to be distributed) by the switching unit 321.

Furthermore, in a case where a singing subject is switched, the switching unit 321 also switches the image to be distributed (switches the image to a clipped image of a subject who is singing subsequently).

Furthermore, the switching (selection) of the distribution image by the switching unit 321 is automatically performed as described above, but the present invention is not limited thereto, and the switching unit 321 may receive a switching operation by an operator (for example, switcher) of the distribution switching device 30. For example, the control unit 320 may display a plurality of clipped images (distribution image candidates) output from the content generation device 20 on the display unit 340 and cause the operator to freely perform selection. At this time, the display unit 340 may also display information regarding subjects being clipped (popularity, number of followers, center, and the like) and make recommendation to the operator.

Furthermore, the switching unit 321 may match the switching timing of the distribution image to the tempo (beats per minut (BPM)) of the music being sung by subjects. The switching unit 321 can extract the BPM from an input sound source (such as voice collected by a microphone of a subject). Furthermore, the switcher may input BPM by touching a touch panel display (in which the operation input unit 330 and the display unit 340 are integrated) in accordance with the rhythm (performing touching at regular intervals in accordance with the melody).

Furthermore, the switching unit 321 may perform switching in accordance with a timing at which the operator presses a switching button. The image to be switched can be automatically selected by the switching unit 321. Neither a director nor a switcher is required at the site due to reduction in the number of people during distribution according to the present system, and a case of only a manager is assumed. However, even if the manager does not have operational knowledge like a switcher, for example, the manager can easily switch the distribution image by pressing the switching button at any timing in accordance with the melody.

Note that candidates for the distribution image include an overhead image acquired from the camera 10d as described with reference to FIG. 1, but the overhead image has low priority. Therefore, the overhead image of the camera 10d may be selected as the distribution image, for example, in a case where no one is singing, or in a case where there is no subject on the stage (at the beginning, the end, or the like of a song).

### (Operation Input Unit 330 and Display Unit 340)

The operation input unit 330 receives an operation input by an operator and outputs input information to the control unit 220. Furthermore, the display unit 340 displays various operation screens and candidates of the distribution image (clipped image). The display unit 340 may be a display panel such as a liquid crystal display (LCD) or an organic electro luminescence (EL) display. The operation input unit 330 and the display unit 340 may be included integrally. For example, the operation input unit 330 may be a touch sensor laminated on the display unit 340 (for example, panel display).

### (Storage Unit 350)

The storage unit 350 is implemented by a read only memory (ROM) that stores programs, arithmetic parameters, and the like to be used for processing of the control unit 320, and a random access memory (RAM) that temporarily stores parameters and the like that change as appropriate.

Although the configuration of the distribution switching device 30 has been specifically described above, the configuration of the distribution switching device 30 according to the present disclosure is not limited to the example illustrated in FIG. 10. For example, the distribution switching device 30 may not include the operation input unit 330 and the display unit 340. Furthermore, the distribution switching device 30 may be implemented by a plurality of devices.

### <<3. Operation Processing>>

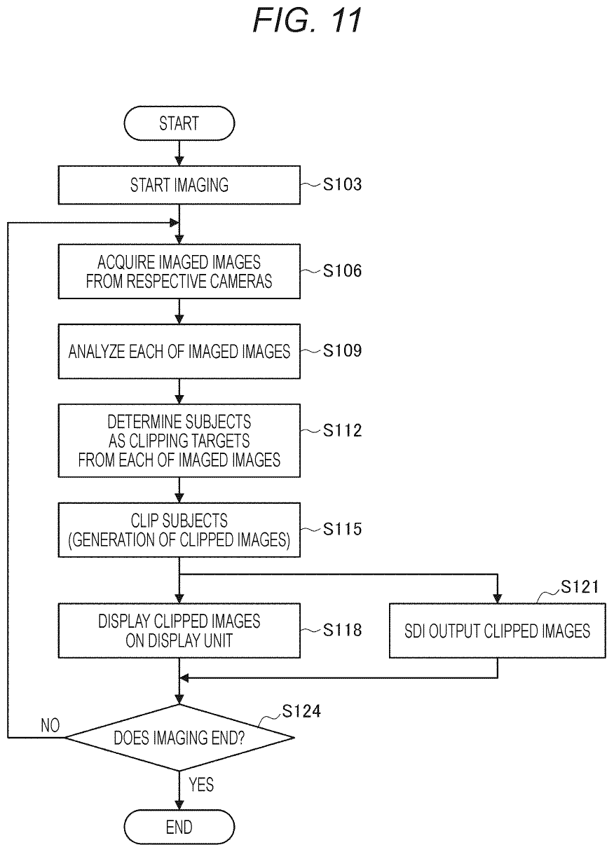

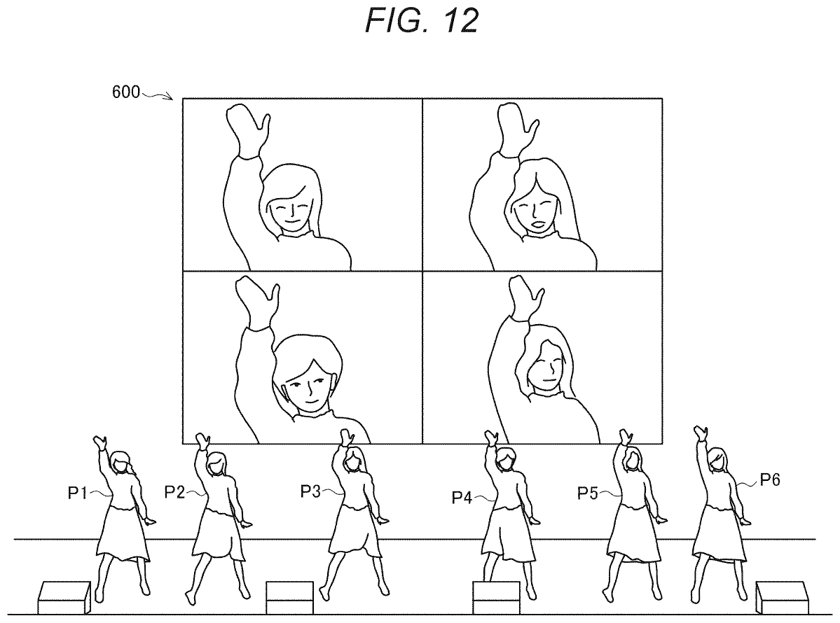

Next, a flow of operation processing of the content generation device 20 according to the present embodiment will be specifically described with reference to the drawings. FIG. 11 is a flowchart illustrating an example of a flow of the operation processing of the content generation device 20 according to the present embodiment.

First, as illustrated in FIG. 3, the control unit 220 of the content generation device 20 controls the cameras 10 (10a to 10c) such that imaging is started (step S103). Distribution can be started by the cameras 10 starting imaging.

Next, the content generation device 20 acquires imaged images from the respective cameras 10a to 10c (step S106).

Next, the clipping processing unit 222 of the content generation device 20 analyzes each of the imaged images (step S109) and identifies subjects.

Next, the clipping processing unit 222 determines subjects as clipping targets by the number of clippings from each of the imaged images (step S112). Note that a group including a plurality of subjects (subject group as a clipping target) is added as 1.

Next, the clipping processing unit 222 clips the subjects by the number of clippings (step S115). That is, the clipping processing unit 222 acquires (generates) clipped images from the imaged images.

Next, the output control unit 223 displays one or more clipped images on the display unit 240 (step S118). Furthermore, the output control unit 223 transmits (SDI outputs) one or more clipped images to the distribution switching device 30 (step S121). The distribution switching device 30 selects an image to be distributed from the one or more clipped images.

The processing (steps S106 to S121) described above is performed for each frame until the imaging (distribution) ends (step S124). Distribution can be performed in real time from the distribution switching device 30.

An example of the flow of the operation processing of the content generation device 20 according to the present embodiment has been described above. Note that the operation processing illustrated in FIG. 11 is an example, and a part of the processing may be performed in different orders or in parallel, or may not be performed.

### 4. Application Examples

Next, application examples of the present embodiment will be described.

FIG. 12 is a diagram illustrating another method of using a clipped image according to an application example of the present embodiment. As illustrated in FIG. 12, the output control unit 223 of the content generation device 20 may arrange and display clipped images side by side on a back screen 600 included on the stage using a multiscreen. The display is not limited to the back screen 600, and may be another large display installed in the venue. The priority order for displaying can be determined on the basis of singing, a region of interest, a center, and the like as described above.

In a case where clipped images of all subjects on the stage can be obtained, the output control unit 223 may always display the clipped images of all the subjects on the stage using a multiscreen. Furthermore, after a subject is LOST (in a case where tracking fails or the subject is lost), the output control unit 223 may display a clipped image of a newly identified subject at the same display position so that the display positions of the respective subjects are not spread on the multiscreen. Note that the output resolution may not be depended on. There may be irregular resolution of an LED display installed in the venue, such as HD, 4K, or 8K.

Furthermore, as another application example, the output control unit 223 may acquire information indicating a clipped image selected for distribution (programmed out) from the distribution switching device 30, and emphasize and display the clipped image selected for distribution in real time on the display screen illustrated in FIG. 4. As a result, the director can easily grasp video currently distributed.

Furthermore, in the above-described embodiment, real-time distribution is assumed, but the present disclosure is not limited thereto. The present system can also be applied during recording for distribution.

Furthermore, in the above-described embodiment, a group of a large number of idols has been mainly described as an example, but the present disclosure is not limited thereto, and a performer and a player are widely included. Furthermore, an event to be imaged is not limited to a music concert, and a musical, a play, a sport, and the like are also assumed.

### 5. Supplement Notes

The preferred embodiment of the present disclosure has been described above in detail with reference to the accompanying drawings, but the present technology is not limited to such an example. It is obvious that those with ordinary skill in the technical field of the present disclosure may conceive various modifications or corrections within the scope of the technical idea recited in claims, and it is naturally understood that they also fall within the technical scope of the present disclosure.

Furthermore, one or more computer programs for causing hardware such as a CPU, a ROM, and a RAM incorporated in the content generation device 20 or the distribution switching device 30 described above to exert functions of the content generation device 20 or the distribution switching device 30 can also be created. Furthermore, a computer-readable storage medium that stores the one or more computer programs is also provided.

Furthermore, the effects disclosed in the present specification are merely illustrative or exemplary, but are not restrictive. That is, the technology according to the present disclosure may achieve other effects obvious to those skilled in the art from the description in the present specification, in addition to or instead of the effects described above.

Note that the present technology may also have the following configurations.

(1)

An information processing device including a control unit that performs control that analyzes an imaged image acquired from one or more imaging devices that image a target space, determines one or more subjects as clipping targets from the imaged image, and clips a determined subject.

(2)

The information processing device according to the (1), in which the control unit performs clipping in a range including at least a face of the subject.

(3)

The information processing device according to the (2), in which the control unit preferentially determines a subject that satisfies a predetermined condition as a clipping target.

(4)

The information processing device according to the (3), in which the control unit determines a singing subject as a clipping target as a subject that satisfies the predetermined condition.

(5)

The information processing device according to the (3), in which the control unit determines a subject positioned in a region of interest as a clipping target as a subject that satisfies the predetermined condition.

(6)

The information processing device according to the (3), in which the control unit determines a subject positioned at a center on a stage that is the target space as a clipping target as a subject that satisfies the predetermined condition.

(7)

The information processing device according to the (1), in which the control unit determines a fixed position on a stage as a clipping target in a case where a number of subjects is less than a predetermined number of clippings.

(8)

The information processing device according to any one of the (2) to (7), in which the control unit performs clipping by a number of clippings corresponding to a number of outputs of an image.

(9)

The information processing device according to any one of the (2) to (8), in which the control unit performs clipping in a range including one subject or clipping in a range including a plurality of subjects.

(10)

The information processing device according to the (9), in which the control unit performs clipping in a range including a predetermined margin above an uppermost part of a body of a subject as a clipping target.

(11)

The information processing device according to the (10), in which the control unit further performs clipping in a range including a margin in an eye line direction in a case where an eye line of a subject as the clipping target is directed to left and right.

(12)

The information processing device according to any one of the (2) to (11), in which the control unit further performs clipping in a range including at least a hand of the subject.

(13)

The information processing device according to any one of the (1) to (12), in which the control unit performs clipping in a range including a plurality of subjects and clipping in a range including one subject included in the plurality of subjects.

(14)

The information processing device according to any one of the (1) to (13), in which the control unit performs clipping in a range including one or more subjects in a predetermined area on a stage.

(15)

The information processing device according to any one of the (1) to (14), in which the imaged image is a plurality of imaged images having partially overlapping view angles acquired from a plurality of imaging devices disposed on a seat side of a stage, and
the control unit arranges and displays the plurality of imaged images side by side in a partially overlapping state, and receives adjustment of an overlapping position.

(16)

The information processing device according to the (15), in which the control unit performs control for outputting a plurality of clipped images obtained by clipping to a device that switches a distribution image, and performs control for displaying the plurality of clipped images on a display unit together with the plurality of imaged images arranged side by side.

(17)

The information processing device according to the (15) or (16), in which in a case where a subject as the clipping target moves from a first imaged image to a second imaged image of the plurality of imaged images arranged side by side, the control unit switches an imaged image of a clipping source at a portion where the first imaged image and the second imaged image overlap.

(18)

An information processing method performed by a processor, including
performing control that analyzes an imaged image acquired from one or more imaging devices that image a target space, determines one or more subjects as clipping targets from the imaged image, and clips a determined subject.

(19)

A program that causes a computer to function as
a control unit that performs control that analyzes an imaged image acquired from one or more imaging devices that image a target space, determines one or more subjects as clipping targets from the imaged image, and clips a determined subject.

### REFERENCE SIGNS LIST

10 Camera (imaging device)
20 Content generation device
210 Communication unit
220 Control unit
221 Display position adjustment unit
222 Clipping processing unit
223 Output control unit
230 Operation input unit
240 Display unit
250 Storage unit
30 Distribution switching device
310 Communication unit
320 Control unit
321 Switching unit
322 Distribution control unit
330 Operation input unit
340 Display unit
350 Storage unit

1. An information processing device comprising
a control unit that performs control that analyzes an imaged image acquired from one or more imaging devices that image a target space, determines one or more subjects as clipping targets from the imaged image, and
clips a determined subject.

2. The information processing device according to claim 1, wherein the control unit performs clipping in a range including at least a face of the subject.

3. The information processing device according to claim 2, wherein the control unit preferentially determines a subject that satisfies a predetermined condition as a clipping target.

4. The information processing device according to claim 3, wherein the control unit determines a singing subject as a clipping target as a subject that satisfies the predetermined condition.

5. The information processing device according to claim 3, wherein the control unit determines a subject positioned in a region of interest as a clipping target as a subject that satisfies the predetermined condition.

6. The information processing device according to claim 3, wherein the control unit determines a subject positioned at a center on a stage that is the target space as a clipping target as a subject that satisfies the predetermined condition.

7. The information processing device according to claim 1, wherein the control unit determines a fixed position on a stage as a clipping target in a case where a number of subjects is less than a predetermined number of clippings.

8. The information processing device according to claim 2, wherein the control unit performs clipping by a number of clippings corresponding to a number of outputs of an image.

9. The information processing device according to claim 2, wherein the control unit performs clipping in a range including one subject or clipping in a range including a plurality of subjects.

10. The information processing device according to claim 9, wherein the control unit performs clipping in a range including a predetermined margin above an uppermost part of a body of a subject as a clipping target.

11. The information processing device according to claim 10, wherein the control unit further performs clipping in a range including a margin in an eye line direction in a case where an eye line of a subject as the clipping target is directed to left and right.

12. The information processing device according to claim 2, wherein the control unit further performs clipping in a range including at least a hand of the subject.

13. The information processing device according to claim 1, wherein the control unit performs clipping in a range including a plurality of subjects and clipping in a range including one subject included in the plurality of subjects.

14. The information processing device according to claim 1, wherein the control unit performs clipping in a range including one or more subjects in a predetermined area on a stage.

15. The information processing device according to claim 1,
wherein the imaged image is a plurality of imaged images having partially overlapping view angles acquired from a plurality of imaging devices disposed on a seat side of a stage, and
the control unit arranges and displays the plurality of imaged images side by side in a partially overlapping state, and receives adjustment of an overlapping position.

16. The information processing device according to claim 15, wherein the control unit performs control for outputting a plurality of clipped images obtained by clipping to a device that switches a distribution image, and performs control for displaying the plurality of clipped images on a display unit together with the plurality of imaged images arranged side by side.

17. The information processing device according to claim 15, wherein in a case where a subject as the clipping target moves from a first imaged image to a second imaged image of the plurality of imaged images arranged side by side, the control unit switches an imaged image of a clipping source at a portion where the first imaged image and the second imaged image overlap.

18. An information processing method performed by a processor, comprising
performs control that analyzes an imaged image acquired from one or more imaging devices that image a target space, determines one or more subjects as clipping targets from the imaged image, and clips a determined subject.

19. A program that causes a computer to function as
a control unit that performs control that analyzes an imaged image acquired from one or more imaging devices that image a target space, determines one or more subjects as clipping targets from the imaged image, and clips a determined subject.
